(19) United States
(12) Patent Application Publication
(10) Pub. No.: US 2020/0124421 A1
(43) Pub. Date: Apr. 23, 2020

(54) METHOD AND APPARATUS FOR ESTIMATING POSITION

(71) Applicant: SAMSUNG ELECTRONICS CO., LTD., Suwon-si (KR)

(72) Inventors: Chul Woo KANG, Suwon-si (KR); Wonhee LEE, Yongin-si (KR); Kyungboo JUNG, Seoul (KR); Hwiryong JUNG, Seoul (KR)

(73) Assignee: SAMSUNG ELECTRONICS CO., LTD., Suwon-si (KR)

(21) Appl. No.: 16/357,794

(22) Filed: Mar. 19, 2019

(30) Foreign Application Priority Data
Oct. 19, 2018 (KR) 10-2018-0125159

(51) Int. Cl. G01C 21/30; G01S 13/86; G01S 19/07; G01S 17/06; G01S 13/06

(52) U.S. Cl. CPC G01C 21/30; G01S 13/865; G01S 13/06; G01S 19/07; G01S 17/06; G01S 13/867

(57) ABSTRACT

A method and apparatus for estimating a position of a target is provided. The apparatus estimates a position of a target vehicle based on sensing data, calculates an error of the estimated position of the target based on the estimated position, acquired map data, and captured image data, and corrects the estimated position of the target based on the calculated error of the estimated position.

### CROSS-REFERENCE TO RELATED APPLICATION

This application claims the benefit under 35 USC § 119(a) of Korean Patent Application No. 10-2018-0125159 filed on Oct. 19, 2018 in the Korean Intellectual Property Office, the entire disclosure of which is incorporated herein by reference for all purposes.

### BACKGROUND

### 1. Field

The following description relates to technology for estimating a position.

### 2. Description of Related Art

When a vehicle or similar mode of transportation is in motion, a navigational system associated with the vehicle receives radio waves from a satellite belonging to a plurality of global positioning systems (GPS), and verifies a current position of the vehicle or moving object, and a speed of the vehicle or moving object. The navigational system may calculate a three-dimensional (3D) current position of the vehicle, including latitude, longitude, and altitude information based on information received from a GPS receiver. However, GPS signals may include a GPS position error of about 10 meters (m) to 100 m. Such position error may be corrected using other information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a position estimation method performed by a processor, the method includes estimating a position of a target based on sensing data acquired by a first sensor, calculating an error of the estimated position of the target based on the estimated position, acquired map data, and captured image data, and correcting the estimated position of the target based on the calculated error of the estimated position.

The calculating of the error of the estimated position may include identifying a map landmark corresponding to the estimated position of the target from the map data, detecting an image landmark from the image data, and calculating the error of the estimated position based on a difference between the identified map landmark and the detected image landmark.

The calculating of the error of the estimated position may further include calculating at least one of a position error and a pose error as the error based on a position and a pose of the target.

The identifying of the map landmark may further include identifying the map landmark among a plurality of landmarks of the map data to be included in an angle of field of a second sensor configured to capture the image data based on the estimated position and a pose of the target.

The identifying of the map landmark may further include acquiring the map landmark by converting three-dimensional (3D) coordinates of a landmark included in the map data into two-dimensional (2D) coordinates on an image.

The calculating of the error of the estimated position may include calculating the error of the estimated position based on light detection and ranging (LiDAR) data and radio detection and ranging (RADAR) data in addition to calculating the error of the estimated position based on the captured image data and the acquired map data.

The calculating of the error of the estimated position may further include calculating the error of the estimated position based on at least two landmarks among the map landmark based on the map data, the image landmark based on the image data, a LiDAR landmark based on the LiDAR data, and a RADAR landmark based on the RADAR data.

The position estimation method may further include acquiring an inertial measurement unit (IMU) signal and a global positioning system (GPS) signal indicating an acceleration and an angular velocity of the target as the sensing data.

The correcting of the estimated position may include determining a final position of the target by applying non-linear filtering based on the calculated error to the estimated position.

The determining of a final position of the target may include applying the non-linear filtering to the estimated position of the target under a constraint based on a dynamic model corresponding to the target.

In a general aspect, a position estimation apparatus includes a first sensor configured to acquire sensing data, and a processor configured to estimate a position of a target based on the acquired sensing data, calculate an error of the estimated position of the target based on the estimated position, acquired map data, and captured image data, and correct the estimated position of the target based on the calculated error of the estimated position.

The processor may be configured to identify a map landmark corresponding to the estimated position of the target from the map data, detect an image landmark from the image data, and calculate the error of the estimated position based on a difference between the identified map landmark and the detected image landmark.

The processor may be configured to calculate at least one of a position error and a pose error as the error based on a position and a pose of the target.

The processor may be configured to identify the map landmark among a plurality of landmarks of the map data to be included in an angle of field of a second sensor configured to capture the image data based on the estimated position and a pose of the target.

The processor may be configured to acquire the map landmark by converting three-dimensional (3D) coordinates of a landmark included in the map data into two-dimensional (2D) coordinates on an image.

The sensor may be configured to sense at least one of light detection and ranging (LiDAR) data and radio detection and ranging (RADAR) data as additional data and the processor may be configured to calculate the error of the estimated position further based on the additional data in addition to calculating the error of the estimated position based on the captured image data and the acquired map data.

The processor may be configured to calculate the error of the estimated position based on at least two landmarks among the map landmark based on the map data, the image landmark based on the image data, a LiDAR landmark based on the LiDAR data, and a RADAR landmark based on the RADAR data.

The sensor may be configured to acquire an inertial measurement unit (IMU) signal and a global positioning system (GPS) signal indicating an acceleration and an angular velocity of the target as the sensing data.

The processor may be configured to determine a final position of the target by applying nonlinear filtering based on the calculated error to the estimated position.

In a general aspect, a position estimation method performed by a processor includes acquiring sensing data from a first sensor, estimating a position of a target vehicle based on the sensing data, acquiring, image data from a second sensor, acquiring map information corresponding to the estimated position of the target vehicle, detecting an image landmark from the image data and detect a map landmark from the map information, calculating an error in the estimated position of the target vehicle based on a coordinate difference between the image landmark and the map landmark, and obtain a final position of the target vehicle based on the estimated position of the target vehicle, the calculated error, and a dynamic model.

The first sensor may include an inertial sensor module and a global positioning system (GPS) module, and the second sensor comprises an image sensor.

The position estimation method may include applying one or more of Kalman filtering and non-linear filtering to the estimated position of the target vehicle, the error of the estimated position, and the dynamic model.

The calculating of the error further may include calculating the error of the estimated position based on light detection and ranging (LiDAR) data and radio detection and ranging (RADAR) data.

Other features and aspects will be apparent from the following detailed description, the drawings, and the claims.

### BRIEF DESCRIPTION OF DRAWINGS

FIG. 1 illustrates an example of a position estimation apparatus;

FIGS. 2 and 3 illustrate examples of a position estimation apparatus;

FIG. 4 illustrates an example of a position estimation method;

FIG. 5 illustrates an example of a position estimation process;

FIG. 6 illustrates an example of a position estimation process in detail; and

FIG. 7 illustrates an example of a position estimation method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application

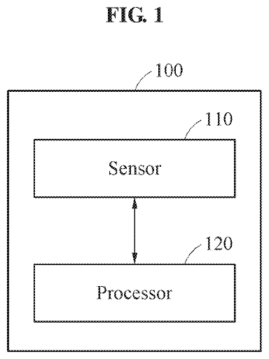

FIG. 1 is a block diagram illustrating an example of a position estimation apparatus.

FIG. 1 illustrates a configuration of a position estimation apparatus 100. The position estimation apparatus 100 includes a sensor 110 and a processor 120.

The sensor 110 generates sensing data. For example, the sensor 110 generates sensing data by sensing information used for estimating a position. The information used for estimating the position may include various signals, for example, global positioning system (GPS) signals, an acceleration signal, a speed signal, and an image signal, but is not limited thereto.

It is noted that use of the term “may” with respect to an example or embodiment, e.g., as to what an example or embodiment may include or implement, means that at least one example or embodiment exists where such a feature is included or implemented while all examples and embodiments are not limited thereto.

The processor 120 estimates a position of a target from the sensing data. The processor 120 calculates an error of the estimated position based on the estimated position, map data, and image data. The processor 120 corrects the estimated position based on the calculated error. For example, the processor 120 primarily estimates a position of the target from the sensing data. Then, the processor 120 calculates an error of the primarily estimated position based on the map data and the image data. The processor 120 secondarily re-estimates a position of the target through non-linear filtering based on the primarily estimated position, the calculated error, and a dynamic model.

In the disclosed examples, the term “target” refers to an apparatus that includes the position estimation apparatus 100. For example, when the position estimation apparatus 100 is located in a vehicle, the target may be the vehicle.

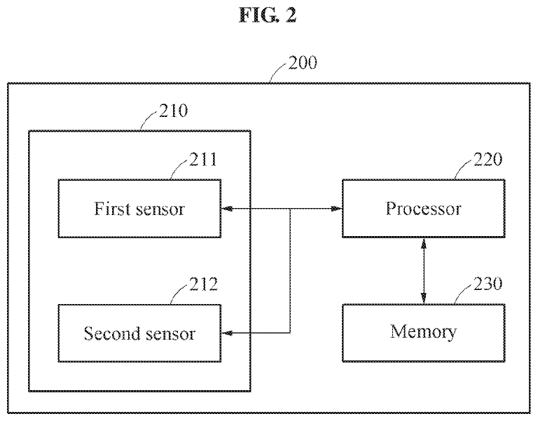

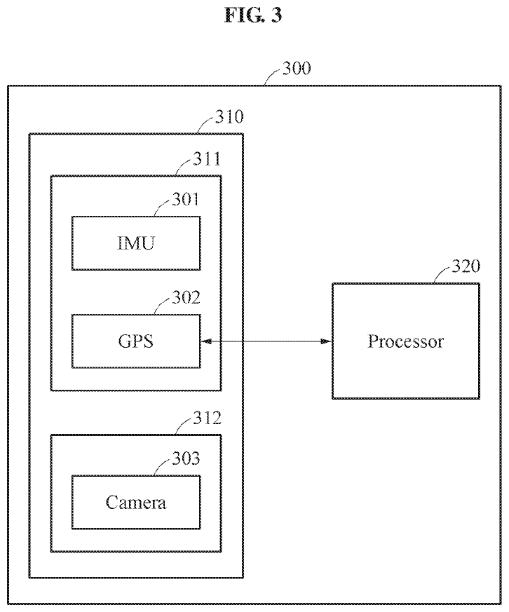

FIGS. 2 and 3 are block diagrams illustrating examples of a position estimation apparatus.

FIG. 2 is a block diagram illustrating an example of a position estimation apparatus 200. The position estimation apparatus 200 includes a sensor 210, a processor 220, and a memory 230.

The sensor 210 may include a first sensor 211 and a second sensor 212. Although only a first sensor 211 and a second sensor 212 are illustrated in FIG. 2, this is only an example, and more than two sensors may be implemented.

The first sensor 211 may generate first sensing data. For example, the first sensor 211 may include an inertial sensor module and a GPS module. Data sensed by the inertial sensor module may be updated based on inertial navigation. An example of the first sensor will be further described with reference to FIG. 3.

The second sensor 212 may generate second sensing data. For example, the second sensor 212 may include a camera. The camera may measure a relative path at 1 to 10 hertz (Hz), or may measure an absolute position through map matching. The camera may generate a lower drift as compared to an inertial sensor module. Image data is preprocessed using various image processing techniques.

The first sensor 211 and the second sensor 212 may collect asynchronous sensing data.

Basically, the processor 220 may estimate a position of a target based on first sensing data acquired from the first sensor 211. The processor 220 calculates an error of the position of the target that is estimated based on the first sensing data, based on second sensing data acquired from the second sensor 212. Here, the processor 220 calculates the error based on the second sensing data and map data received from an external device, for example, a server or stored in the memory 230.

For example, the first sensor 211, which may include a GPS module, may operate efficiently in a wide-open space if obstacles are not blocking GPS signals, and the second sensor 212, which may include a camera, may malfunction due to ambient light and object characteristics. The processor 220 hierarchically applies each sensing data to a position estimation process to prevent an error from occurring due to sensor malfunction. The position estimation based on the second sensing data and the map data will be further described later.

The memory 230 temporarily or permanently stores data required for a position estimation process. For example, the memory 230 may time-sequentially store the first sensing data acquired from the first sensor 211 and the second sensing data acquired from the second sensor 212. Also, the memory 230 may store a map of an area including a region in which a target is located and an image, for example, a 360-degree panoramic image of a scene captured at each point on the map.

The position estimation apparatus 200 may precisely estimate a position of a vehicle in lane units by fusing the first sensing data acquired from the first sensor 211 and the second sensing data acquired from the second sensor 212.

Although FIG. 2 illustrates two sensors, the number of sensors is not limited thereto. The position estimation apparatus 200 may include n plural-type sensors, n being an integer greater than or equal to “1”.

FIG. 3 is a diagram illustrating a sensor 310 included in a position estimation apparatus 300.

The sensor 310 may include a first sensor 311 and a second sensor 312.

The first sensor 311 may generate first sensing data. For example, the first sensor 311 may include an inertial measurement unit (IMU) 301 and a GPS module 302. The first sensor 311 may acquire an IMU signal and a GPS signal indicating an acceleration and an angular velocity of the target as first sensing data.

The IMU 301 is also referred to as “inertial sensor module”. The IMU 301 measures a change in pose, a change in speed with regard to positional movement, and a displacement. The IMU 301 may include a three-axis accelerometer that senses a translational motion, for example, an acceleration, and a three-axis gyroscope that senses a rotational motion, for example, an angular velocity. Since the IMU 301 may not depend on external information, an acceleration signal and an angular velocity signal may be stably collected.

However, since a calculated position may diverge as the sensing time of the IMU 301 is accumulated, a processor 320 may stably estimate a position of a vehicle or landmark by fusing the GPS signal and the image data to the IMU signal. The GPS module 302 receives signals transmitted from at least three artificial satellites, and uses the received signals to calculate positions of the satellites and the position estimation apparatus 300, and may also be referred to as a global navigation satellite system (GNSS). The GPS module 302 may measure an absolute position with a low sample period and stably operate because an error is not accumulated. The IMU 301 may measure a change in position with a high sampling period and have a fast response time.

The second sensor 312 may generate second sensing data. For example, the second sensor 312 may include a camera 303. The camera 303 captures an external view, for example, a front view of the position estimation apparatus 300 to generate image data. However, the type of the second sensor 312 is not limited thereto, and other types of sensors may be implemented. A sensing module having a lower reliability and a higher accuracy as compared to the first sensor 311 may be implemented as the second sensor 312.

The processor 320 may operate in a manner similar to that described with reference to FIGS. 1 and 2. The processor 320 may receive an IMU signal from the IMU 301, and may receive a GPS signal from the GPS module 302, thereby estimating a position of the target. The processor 320 may estimate a motion of the target by fusing a pose, a speed, and a position updated for the target through inertial navigation to GPS information.

The processor 320 may be used for position estimation only when second sensing data is accurate and has a high reliability. For example, the processor 320 determines whether to use image data for the position estimation based on a status of the image data. When the second sensing data is image data and has a high reliability, the processor 320 uses the image data to collect visual information associated with surroundings of the target.

The processor 320 primarily estimates a position and a pose of the target based on the first sensing data. By using the primarily estimated position and pose, the processor 320 extracts, from map data, a candidate landmark that is to be captured by a second sensor. The processor 320 converts 3D coordinates of the candidate landmark into 2D coordinates based on the position and pose estimated using the GPS signal and IMU signal. The processor 320 identifies a map landmark that is to appear in an angle of field of the camera 303 from the candidate landmark.

The processor 320 calculates an error of the first sensing data using a map landmark identified from the map data based on the first sensing data and an image landmark detected from the image data acquired by the camera 303. The processor 320 performs object recognition on a surrounding area of 2D coordinates identified from the image data acquired by the camera 303 based on 2D coordinates of the map landmark identified from the map data. In terms of the object recognition, at least one of a typical image processing scheme or a deep-learning based recognition may be applied.

The processor 320 applies Kalman filtering or non-linear filtering, for example, particle filtering to the primarily estimated position, an error of the primarily estimated position, and a dynamic model. The Kalman filtering is one of typical sensor fusion techniques and may be a filtering technique that minimizes a root mean square error (RMSE) of an error of a state variable to be estimated. An error due to a non-linearity may occur while the processor 320 processes a measured value, for example, image data which includes the non-linearity acquired by a second sensor such as a camera. The processor 320 may minimize the error due to the non-linearity by using a non-linear filter to process such image data.

The processor 320 estimates a position of the target by fusing information estimated and calculated from each sensing data through the Kalman filtering or the non-linear filtering. When at least a portion of the sensors among a plurality of sensors are vulnerable to a change in external environment, the processor 320 may collect incorrect sensing data. When the Kalman filtering is applied to the incorrect sensing data, an error may occur due to an incorrect measured value, which may reduce an accuracy of position estimation. In order to increase the accuracy and maintain a reliability of the position estimation, the position estimation apparatus 300 selectively uses the error calculated based on the second sensing data in accordance with a reliability.

The processor 320 may use at least two filtering techniques instead of the single Kalman filtering. The processor 320 applies each filtering technique independently in different layers so as to minimize a degree to which a failure of the second sensor 312 affects the position estimation performed based on the first sensor 311. When the second sensor 312 is unreliable, the processor 320 estimates a position based on only the first sensing data and excludes the unreliable second sensing data in the position estimation of a current time period and a subsequent time period. Also, when the second sensor 312 is reliable, the processor 320 re-estimates a position based on both of the first sensing data and the second sensing data.

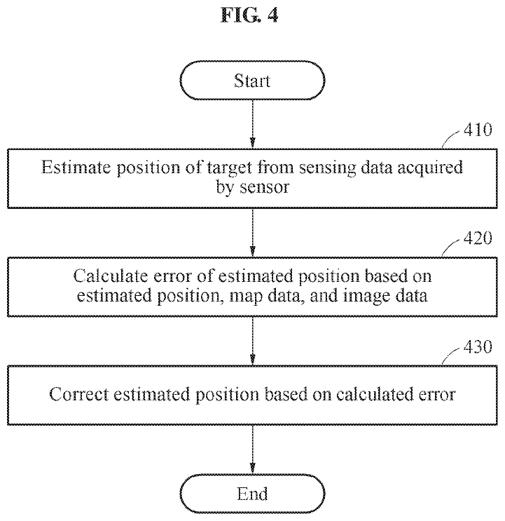

FIG. 4 is a flowchart illustrating an example of a position estimation method. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. One or more blocks of FIG. 4, and combinations of the blocks, can be implemented by special purpose hardware-based computer that perform the specified functions, or combinations of special purpose hardware and computer instructions.

With regard to the discussion pertaining to FIG. 4, references to the sensor may refer to the first sensor 211 as illustrated in FIG. 2, or the first sensor 311 as illustrated in FIG. 3.

In operation 410, a position estimation apparatus estimates a position of a target based on sensing data acquired by a sensor. The position estimation apparatus acquires an IMU signal and a GPS signal indicating an acceleration and an angular velocity of the target as sensing data. However, a type of sensing data is not limited thereto. The sensor may sense at least one of light detection and ranging (LiDAR) data and radio detection and ranging (RADAR) data as additional data.

In operation 420, the position estimation apparatus calculates an error of the estimated position based on the estimated position, map data, and image data. The position estimation apparatus identifies a map landmark corresponding to a position estimated from map data. The position estimation apparatus detects an image landmark from image data. The position estimation apparatus calculates an error of the estimated position based on a difference between the map landmark and the image landmark. However, the present example is not to be taken as being limited thereto. The position estimation apparatus may calculate an error of the estimated position further based on additional data in addition to the map data and the image data.

The image landmark is a landmark appearing in an image. The map landmark is a landmark appearing in the map data. A landmark is an object fixed at a predetermined geographical position to provide a driver with information required to drive a vehicle on a road. For example, road signs and traffic lights may be considered as landmarks. According to the Korean Road Traffic Act, landmarks are classified into six classes, for example, a caution sign, a regulatory sign, an indication sign, an auxiliary sign, a road sign, and a signal sign. However, classification of the landmarks is not limited to the foregoing. Classes of the landmark may differ for individual countries.

In operation 430, the position estimation apparatus corrects the estimated position of the target based on the calculated error. The position estimation apparatus determines a final position of the target by applying non-linear filtering to the estimated position based on the calculated error.

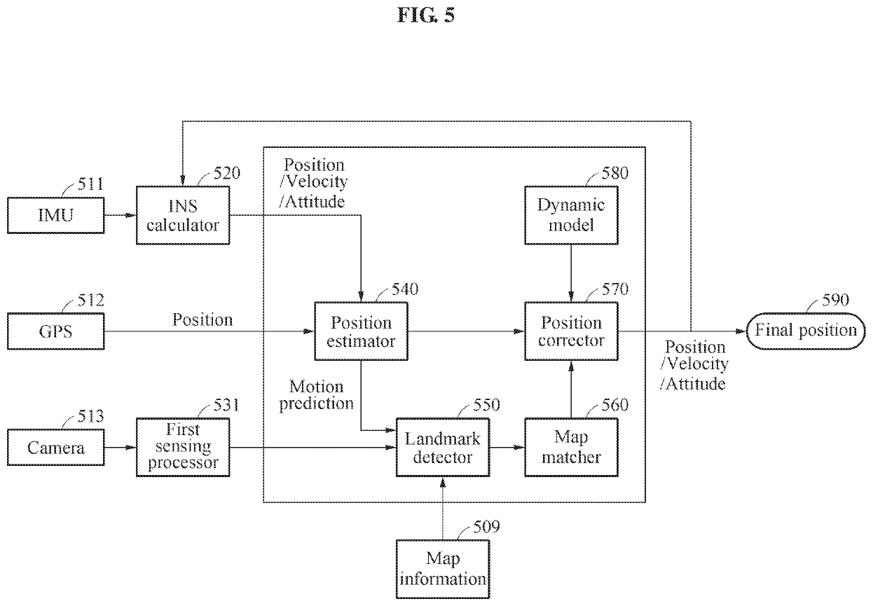

FIG. 5 is a diagram illustrating an example of a position estimation process.

Referring to FIG. 5, an inertial navigation system (INS) calculator 520, a first sensing processor 531, a position estimator 540, a landmark detector 550, a map matcher 560, and a position corrector 570 may be software modules operated by a processor. For example, by using a software structure as shown in FIG. 5, the position estimation apparatus may perform accurate positioning.

As described above, an IMU 511 measures a change in pose, a change in speed with regard to position movement, and a displacement of the target.

The INS calculator 520 calculates a position, a velocity, and an attitude of a target based on an IMU signal measured by the IMU 511 and INS time propagation. For example, the INS calculator 520 determines a position, a velocity, and an attitude of the target for a current time frame based on a final position 590, a velocity, and an attitude of the target determined for a previous time frame.

As described above, a GPS module 512 senses a GPS signal.

The position estimator 540 estimates a position of the target based on sensing data acquired from a sensor. In the example of FIG. 5, the sensor may include the IMU 511 and the GPS module 512, and the sensing data may include an IMU signal obtained by the IMU 511 and a GPS signal obtained by the GPS module 512. The position estimator 540 primarily estimates a position of the target based on INS information calculated by the INS calculator 520 and a GPS signal sensed by a GPS.

A camera 513 acquires image data. The first sensing processor 531 acquires the image data from the camera 513 and performs a preprocessing operation, for example, a color correction operation and a brightness correction operation for converting the image data to be used for a positioning process.

The landmark detector 550 detects an image landmark from the image data, and a map landmark from map information. For example, the landmark detector 550 detects a landmark appearing in preprocessed image data, hereinafter, referred to as “image landmark” from the image data. Also, the landmark detector 550 detects a landmark corresponding to the position and the attitude estimated by the position estimator 540 from map information 509. For example, the landmark detector 550 extracts a candidate landmark, for example, a landmark around the estimated position of the target, corresponding to the position and attitude estimated by the position estimator 540 among a plurality of landmarks included in the map information 509. The landmark detector 550 determines a landmark to be captured in the image data based on an angle of field of the camera 513, hereinafter, referred to as “map landmark” among candidate landmarks. Also, the landmark detector 550 may perform only landmark detection calculation in a restricted area using the candidate landmark estimated from a current position and attitude calculated by the position estimator 540. Through this, the landmark detector 550 may perform an algorithm with a reduced amount of calculation.

The map matcher 560 matches the image landmark and the map landmark detected by the landmark detector 550. The map matcher 560 calculates an error of the position primarily estimated by the position estimator 540 based on the image landmark and the map landmark. For example, the map matcher 560 calculates the error of the position estimated by the position estimator 540 based on a coordinate difference between the image landmark and the map landmark.

For convenience of explanation, all of the identified map landmarks and all of the detected image landmarks are matched, but embodiments are not limited thereto. For example, an identified landmark among map landmarks to be included in the image data captured by the camera 513 may be obscured by obstacles (e.g., objects other than landmarks, such as a vehicle or a tree). Even when the landmarks obscured by the obstacles are identified to be included in an angle of field of an image sensor based on map data, the landmarks may not be detected in real image data. In this example, the landmark detector 550 may exclude the landmarks obscured by the obstacles among the identified map landmarks. The map matcher 560 calculates a coordinate difference between the image landmark recognized from the image data and remaining landmarks not obscured by the obstacles among the identified map landmarks, for example, a coordinate difference on map data. The map matcher 560 calculates a position error and an attitude error based on the image landmark recognized from the image data and a map landmark corresponding to the image landmark. The map matcher 560 transfers the position error and the attitude error to a final sensor fusion filter, for example, the position corrector 570.

The position corrector 570 determines the final position 590 of the target based on the position estimated by the position estimator 540, the error calculated by the map matcher 560, and a dynamic model 580. For example, the position corrector 570 determines the final position 590 of the target by applying non-linear filtering based on the calculated error to the estimated position. Here, the position corrector 570 applies the non-linear filtering to the estimated position under a constraint based on the dynamic model 580 corresponding to the target. When an error-corrected position deviates from a motion modeled by the dynamic model 580, the position corrector 570 may exclude the corrected position and calculate the final position 590 of the target.

In an example in which a vehicle moves straight-ahead only, sensor information for correcting the vehicle to another attitude, for example, an attitude other than a straight-ahead attitude, may be a result of an erroneous calculation. The position corrector 570 may exclude the corrected position determined as the result of erroneous calculation as in the example described above.

Additionally, the position corrector 570 may perform correction using a landmark pixel error in an image in addition to a position-corrected value of the estimated vehicle. The position corrector 570 calculates a final velocity and a final attitude of the target in addition to the final position 590.

The position corrector 570 estimates a final position, a velocity, and an attitude of the target for a current time frame based on a result obtained by fusing sensing data sensed by the GPS module 512 and the IMU 511, a correction value calculated through map matching, and a dynamic model of the target, for example, the vehicle. In this example, a non-linear filter may include a non-linear estimator, for example, a Kalman filter, an extended Kalman filter, an unscented Kalman filter (UKF), a cubature Kalman filter (CKF), or a particle filter.

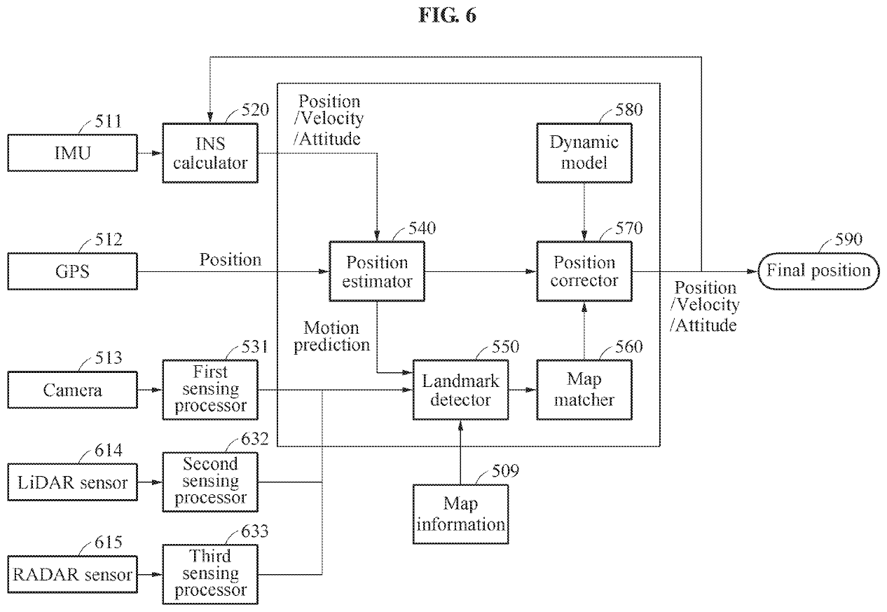

FIG. 6 is a diagram illustrating an example of a position estimation process in detail.

With regard to the discussion pertaining to FIG. 6, references to the IMU, the INS calculator, the GPS, the camera, the first sensing processor, the position estimator, the landmark detector, the map matcher, the position corrector, the dynamic model, the map information, and the final position, may refer to the IMU 511, the INS calculator 520, the GPS 512, the camera 513, the first sensing processor 531, the position estimator 540, the landmark detector 550, the map matcher 560, the position corrector 570, the dynamic model 580, the map information 509, and the final position 590 as illustrated in FIG. 5.

A position estimation apparatus may further include a LiDAR sensor 614, a RADAR sensor 615, a second sensing processor 632, and a third sensing processor 633. Other modules may operate in manner similar to that described with reference to FIG. 5.

The LiDAR sensor 614 senses a LiDAR signal. The LiDAR sensor 614 emits a LiDAR signal, for example, a pulse laser light, and measures a reflected pulse, thereby measuring a distance from a point at which laser light is reflected. The LiDAR sensor 614 generates a surrounding depth map based on the LiDAR signal. The surrounding depth map refers to a map indicating distances from surrounding objects based on a sensor. The second sensing processor 632 performs processing for converting the LiDAR signal sensed by the LiDAR sensor into information to be used in a positioning process.

The RADAR sensor 615 senses a RADAR signal. The RADAR sensor 615 emits the RADAR signal and measures the reflected RADAR signal, thereby measuring a distance from a point at which the RADAR signal is reflected. The RADAR sensor 615 generates a surrounding depth map. The third sensing processor 633 performs processing for converting the RADAR signal sensed by the RADAR sensor 615 into information to be used in a positioning process.

The landmark detector 550 detects landmarks from the LiDAR data and the RADAR data in addition to the image data captured by the camera 513.

The map matcher 560 further calculates an error of an estimated position of a target based on the LiDAR data and the RADAR data in addition to the image data obtained by the camera 513 and map data. For example, the map matcher 560 may calculate the error based on at least two landmarks among a map landmark based on the map data, an image landmark based on the image data, a LiDAR landmark based on the LiDAR data, and a RADAR landmark based on the RADAR data. The map matcher 560 calculates coordinate differences between landmarks and determines an error from the calculated coordinate differences.

In this disclosure, the term “LiDAR landmark” refers to a landmark appearing in the LiDAR data. The term “RADAR landmark” refers to a landmark appearing in the RADAR data. The landmark, as described above, refers to an object fixed at a predetermined position to provide a user with information, for example, information related to driving.

A position corrector determines the final position 590 of the target by correcting an initial position using an error calculated based on landmarks detected from a variety of data.

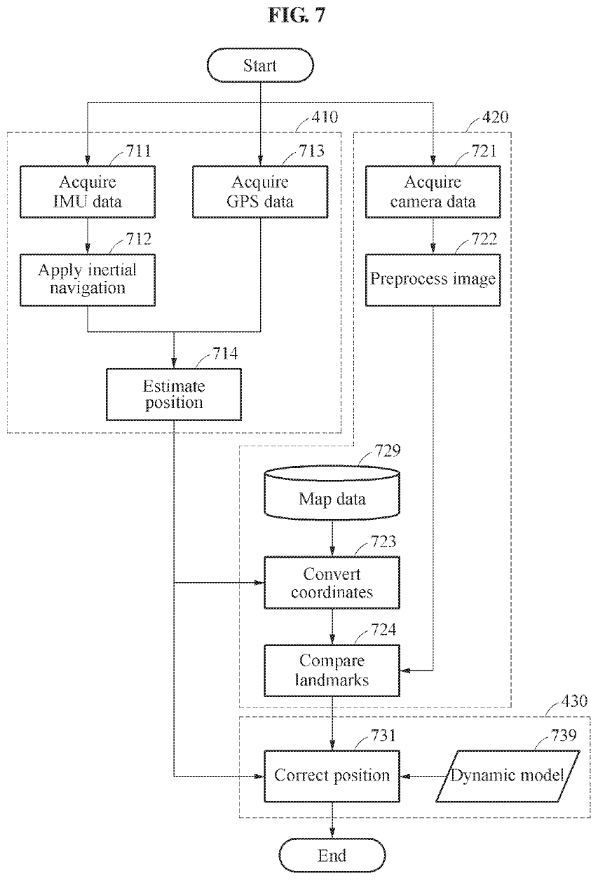

FIG. 7 is a flowchart illustrating an example of a position estimation method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer that perform the specified functions, or combinations of special purpose hardware and computer instructions.

In operation 711, a position estimation apparatus acquires IMU data. The position estimation apparatus generates the IMU data using an IMU module.

In operation 712, the position estimation apparatus applies inertial navigation to the IMU data. The position estimation apparatus calculates a position of a target by applying the inertial navigation to, for example, an acceleration signal and an angular velocity signal. The inertial navigation is a positioning scheme for updating a position, a speed, and a pose of a current time from a position, a speed, and a pose of a previous time using an acceleration signal and an angular velocity signal acquired from the IMU module.

In operation 713, the position estimation apparatus acquires GPS data. The GPS data is data acquired from a GPS module and may be, for example, a GPS signal.

In operation 714, the position estimation apparatus estimates a position of a target based on an IMU signal to which the inertial navigation is applied and a GPS signal to which a weight is assigned. The position estimation apparatus estimates a position of the target by applying non-linear filtering on the IMU signal and the GPS signal.

In operation 721, the position estimation apparatus acquires camera data. For example, the position estimation apparatus acquires image data by capturing a front view from a vehicle. However, the angle of view is not limited to a front view of the vehicle. The image data may be captured from a back view and side views of the vehicle.

In operation 722, the position estimation apparatus preprocesses an image. The position estimation apparatus performs image processing on image data, thereby converting the image data into a form suitable for positioning.

In operation 723, the position estimation apparatus converts coordinates of map data 729. The position estimation apparatus acquires a map landmark by converting 3D coordinates of a landmark included in the map data 729 into 2D coordinates based on an angle of field of an image sensor. For example, the position estimation apparatus extracts candidate landmarks around the position estimated in operation 714. The position estimation apparatus converts 3D coordinates of a candidate landmark into 2D coordinates corresponding to a camera frame based on currently estimated position and pose. The position estimation apparatus identifies a map landmark that is to appear in the angle of field of the image sensor among the candidate landmarks extracted from the map data 729. Accordingly, based on the estimated position and a pose of the target, the position estimation apparatus identifies a map landmark that is to appear in the angle of field of the image sensor acquiring the image data among landmarks of the map data 729.

Additionally, the position estimation apparatus detects an image landmark from the image data. For example, the position estimation apparatus detects a real object in a vicinity of an identified pixel coordinate value of the map landmark from the image data using an object recognition technique. The landmark detected from the image data is referred to as “image landmark”.

In operation 724, the position estimation apparatus compares landmarks. Specifically, the position estimation apparatus compares the image landmark detected from the image data and the map landmark identified from the map data 729. The position estimation apparatus calculates an error of the position estimated in operation 714 based on a difference between 2D coordinates of the image landmark and 2D coordinates of the map landmark.

Since the map landmark and the image landmark have pixel coordinates of the same dimension, for example, two dimensions and scale, the difference between the 2D coordinates of the image landmark and the 2D coordinates of the map landmark corresponds to an error between the position estimated in operation 714 and an actual position of the image sensor acquiring the camera data in operation 721. By performing map matching as described in operation 724, the position estimation apparatus may improve a calculation performance and stability through a position correction operation performed on a relatively narrow area.

In operation 731, the position estimation apparatus corrects the position estimated in operation 714 using the error calculated in operation 724. Also, the position estimation apparatus corrects the position using a dynamic model 739. The position estimation apparatus excludes a position corrected to dissatisfy the dynamic model 739 and accept a position corrected to satisfy the dynamic model 739. The dynamic model 739 may also be referred to as “kinematics of machinery model”. Accordingly, even if incorrect matching instantly occurs in operation 724, the position estimation apparatus may isolate such an incorrect matching.

Furthermore, in operation 714, the position estimation apparatus also estimates a pose of the target. In this example, in operation 724, the position estimation apparatus calculates a position error and a pose error based on the pose and the position of the target as the aforementioned error.

The position estimation apparatus may be implemented as a vehicle navigation apparatus or an air navigation apparatus. In addition, the position estimation apparatus may be applied to a robot, a drone, and similar devices which require positioning. Additionally, the position estimation apparatus may perform a positioning algorithm for an autonomous vehicle.

The position estimation apparatus 100, the sensor 110, the processor 120, the position estimation apparatus 200, the sensor 210, including the first sensor 211 and the second sensor 212, and processor 220, the memory 230, position estimation apparatus 300, the sensor 310, including the first sensor 311 and the second sensor 312, the processor 320, the IMU 511, the GPS 512, the camera 513, the INS calculator 520, the first sensing processor 531, the position estimator 540, the landmark detector 550, the map matcher 560, and the position corrector 570, the LiDAR sensor 614, the RADAR sensor 615, the second sensing processor 632, the third sensing processor 633 and other components described herein with respect to FIGS. 1 to 6 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A position estimation method performed by a processor, the method comprising:
estimating a position of a target based on sensing data acquired by a first sensor;
calculating an error of the estimated position of the target based on the estimated position, acquired map data, and captured image data; and
correcting the estimated position of the target based on the calculated error of the estimated position.

2. The position estimation method of claim 1, wherein the calculating of the error of the estimated position comprises:
identifying a map landmark corresponding to the estimated position of the target from the map data;
detecting an image landmark from the image data; and
calculating the error of the estimated position based on a difference between the identified map landmark and the detected image landmark.

3. The position estimation method of claim 2, wherein the calculating of the error of the estimated position further comprises:
calculating at least one of a position error and a pose error as the error based on a position and a pose of the target.

4. The position estimation method of claim 2, wherein the identifying of the map landmark comprises:
identifying the map landmark among a plurality of landmarks of the map data to be included in an angle of field of a second sensor configured to capture the image data based on the estimated position and a pose of the target.

5. The position estimation method of claim 2, wherein the identifying of the map landmark comprises:
acquiring the map landmark by converting three-dimensional (3D) coordinates of a landmark included in the map data into two-dimensional (2D) coordinates on an image.

6. The position estimation method of claim 1, wherein the calculating of the error of the estimated position comprises:
calculating the error of the estimated position based on light detection and ranging (LiDAR) data and radio detection and ranging (RADAR) data in addition to calculating the error of the estimated position based on the captured image data and the acquired map data.

7. The position estimation method of claim 6, wherein the calculating of the error of the estimated position further comprises:
calculating the error of the estimated position based on at least two landmarks among the map landmark based on the map data, the image landmark based on the image data, a LiDAR landmark based on the LiDAR data, and a RADAR landmark based on the RADAR data.

8. The position estimation method of claim 1, further comprising:
acquiring an inertial measurement unit (IMU) signal and a global positioning system (GPS) signal indicating an acceleration and an angular velocity of the target as the sensing data.

9. The position estimation method of claim 1, wherein the correcting of the estimated position comprises:
determining a final position of the target by applying non-linear filtering based on the calculated error to the estimated position.

10. The position estimation method of claim 9, wherein the determining of a final position of the target comprises:
applying the non-linear filtering to the estimated position of the target under a constraint based on a dynamic model corresponding to the target.

11. A non-transitory computer-readable storage medium storing instructions that, when executed by a processor, cause the processor to perform the position estimation method of claim 1.

12. A position estimation apparatus comprising:
a first sensor configured to acquire sensing data; and
a processor configured to:
estimate a position of a target based on the acquired sensing data,
calculate an error of the estimated position of the target based on the estimated position, acquired map data, and captured image data, and
correct the estimated position of the target based on the calculated error of the estimated position.

13. The position estimation apparatus of claim 12, wherein the processor is configured to
identify a map landmark corresponding to the estimated position of the target from the map data,
detect an image landmark from the image data, and
calculate the error of the estimated position based on a difference between the identified map landmark and the detected image landmark.

14. The position estimation apparatus of claim 13, wherein the processor is configured to calculate at least one of a position error and a pose error as the error based on a position and a pose of the target.

15. The position estimation apparatus of claim 13, wherein the processor is configured to identify the map landmark among a plurality of landmarks of the map data to be included in an angle of field of a second sensor configured to capture the image data based on the estimated position and a pose of the target.

16. The position estimation apparatus of claim 13, wherein the processor is configured to acquire the map landmark by converting three-dimensional (3D) coordinates of a landmark included in the map data into two-dimensional (2D) coordinates on an image.

17. The position estimation apparatus of claim 12, wherein the sensor is configured to sense at least one of light detection and ranging (LiDAR) data and radio detection and ranging (RADAR) data as additional data and
the processor is configured to calculate the error of the estimated position further based on the additional data in addition to calculating the error of the estimated position based on the captured image data and the acquired map data.

18. The position estimation apparatus of claim 17, wherein the processor is configured to calculate the error of the estimated position based on at least two landmarks among the map landmark based on the map data, the image landmark based on the image data, a LiDAR landmark based on the LiDAR data, and a RADAR landmark based on the RADAR data.

19. The position estimation apparatus of claim 12, wherein the sensor is configured to acquire an inertial measurement unit (IMU) signal and a global positioning system (GPS) signal indicating an acceleration and an angular velocity of the target as the sensing data.

20. The position estimation apparatus of claim 12, wherein the processor is configured to determine a final position of the target by applying nonlinear filtering based on the calculated error to the estimated position.

21. A position estimation method performed by a processor, the method comprising:
acquiring sensing data from a first sensor;
estimating a position of a target vehicle based on the sensing data;
acquiring image data from a second sensor;
acquiring map information corresponding to the estimated position of the target vehicle;
detecting an image landmark from the image data and detecting a map landmark from the map information;
calculating an error in the estimated position of the target vehicle based on a coordinate difference between the image landmark and the map landmark, and
obtaining a final position of the target vehicle based on the estimated position of the target vehicle, the calculated error, and a dynamic model.

22. The position estimation method of claim 21, wherein the first sensor comprises an inertial sensor module and a global positioning system (GPS) module, and the second sensor comprises an image sensor.

23. The position estimation method of claim 21, further comprising applying one or more of Kalman filtering and non-linear filtering to the estimated position of the target vehicle, the error of the estimated position, and the dynamic model.

24. The position estimation method of claim 21, wherein the calculating of the error further comprises calculating the error of the estimated position based on light detection and ranging (LiDAR) data and radio detection and ranging (RADAR) data.
